(19) United States
(12) Patent Application Publication
(10) Pub. No.: US 2004/0147298 A1
(43) Pub. Date: Jul. 29, 2004

(54) Gaming system for providing game

(76) Inventor: Tomohiro Shinoda, Tokyo (JP)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/743,326

(22) Filed: Dec. 23, 2003

(30) Foreign Application Priority Data
Dec. 27, 2002 (JP) 2002-382432

(51) Int. Cl. G06F 17/00; G06F 19/00

(52) U.S. Cl. 463/1

(57) ABSTRACT

A gaming system (S) comprising a gaming server (10) and one or more gaming terminals (40A, 40B, etc.) is provided for providing a game, which may shift to a special mode. The one or more gaming terminals (40A, 40B, etc.) optionally constitute a gaming machine group (30). The gaming server (10) and the gaming terminals (40A, 40B, etc.) may be connected with each other via a communications network. In this gaming system, a special event may be generated on the basis of features of personal attribute information of players participating in the game. The special event may have a title relating to the features so that the title may be awarded to a winner of the game.

### CROSS-REFERENCE TO THE RELATED APPLICATIONS

This application is based upon and claims a priority from the prior Japanese Patent Application No. 2002-382432 filed on Dec. 27, 2002, the entire contents of which are incorporated herein by reference.

This application is related to co-pending U.S. patent application entitled “Gaming System”, the application being filed on even date herewith. The co-pending application is expressly incorporated herein by reference.

### FIELD OF THE INVENTION

The present invention relates to a gaming system.

### RELATED ART

In a gaming system, a plurality of terminal devices operable by players are connected to a gaming server for providing information on the basis of signals received from the plurality of terminal devices so that the players may enjoy a game or games without actually getting together at one place.

In such services, a video game device is provided for allowing a person to play a golf game with many unspecified players via the Internet (see, for example, Unexamined Japanese Patent Publication No.2002-219282). In the video game device with a gaming system, a golf game server comprises transmitting means for transmitting a personal attribute information input image on receiving a notification of wishing participation in an open tournament from each player, and further can provide a wide variety of games to the players.

However, such services with the gaming system merely allow the players to enjoy the game in remote locations of the players. Thus, if a game may cause a sense of reality, familiarity, and the like in an ordinary situation or normal mode, the services providing the game can cause less opportunity to obtain such sense of reality, familiarity, and the like so as to deteriorate the pleasure of the game. The services with the gaming system may not provide the players with enough satisfaction.

In particular, a game that requires gamesmanship among players is likely to provide a sense of reality, familiarity, and the like. However, pleasure in the game can be deteriorated when such a game is adopted in the above-mentioned gaming system.

### SUMMARY OF THE INVENTION

An object of the present invention is to provide a gaming system capable of increasing the opportunity that players in remote locations obtain the sense of reality, familiarity, and the like, thereby enhancing pleasure in a game so as to intensify the sense of anticipation of the players.

In order to achieve this object, a gaming system according to the present invention comprises: personal attribute information storing means for storing personal attribute information corresponding to each of a plurality of players; and special game shift means for causing the mode of a game to transit to a special mode on the basis of the features of the personal attribute information of the plurality of players.

More specifically, the present invention provides the following.

(1) A gaming system for providing a game, comprising: personal attribute information storing means for storing personal attribute information corresponding to each of a plurality of players; and special game shift means for causing the game to shift from a normal mode to a special mode based on the personal attribute information of at least one of the plurality of players.

(2) The gaming system according to (1), further comprising: player group generating means for generating a player group being composed of the plurality of players based on the personal attribute information of each of the plurality of players, wherein the game is caused to shift from the normal mode to the special mode based on the personal attribute information of each of the players of the player group.

According to an aspect of the present invention described in (1) or (2), a player does not merely enjoy a game with unknown players, but also obtains the pleasure of playing a game in a special mode.

Further, what causes the game to shift to the special mode is the personal attribute information of each of a plurality of players. This permits the providing of the game in which the players can feel sense of connection based on the personal attribute information.

In the present invention, a gaming system may comprise: a plurality of terminal devices operable by players; and a gaming server capable of communicating with a plurality of terminal devices; wherein the gaming server provides a game in which a plurality of players can participate by a plurality of terminal devices; and wherein the gaming server comprises: personal attribute information storing means for storing personal attribute information corresponding to each of a plurality of the players; and special game shift means for causing the game to shift to a special mode on the basis of the features of the personal attribute information corresponding to a plurality of the players.

Further, in the present invention, a gaming system may comprise: a plurality of terminal devices operable by players; and a gaming server capable of communicating with a plurality of terminal devices; wherein the gaming server provides a game in which a plurality of players can participate with a plurality of terminal devices; and wherein the gaming server comprises special game shift means for causing the game to shift to a special mode on the basis of the features of the personal attribute information which corresponds to a plurality of the players participating in the game and which is stored in a recording medium provided in a plurality of the terminal devices.

Furthermore, in the present invention, a gaming system may comprise: a plurality of terminal devices operable by players; and a gaming server capable of communicating with a plurality of terminal devices; wherein the gaming server provides a game in which a plurality of players can participate with the plurality of terminal devices; and wherein the gaming server comprises special game shift means for causing the game to shift to a special mode on the basis of the features of the personal attribute information which corresponds to the plurality of players participating in the game and which is stored in an rewritable recording medium provided in a plurality of the terminal devices.

Further, in the present invention, a gaming system may comprise: a plurality of terminal devices operable by players; and a gaming server capable of communicating with a plurality of terminal devices; wherein the gaming server provides a match-up game into which a plurality of players can participate with a plurality of terminal devices; and wherein the gaming server comprises: personal attribute information storing means for storing personal attribute information corresponding to each of the plurality of players; and special game shift means for causing the game to shift to a special mode on the basis of the features of the personal attribute information corresponding to a plurality of the players.

(3) The gaming system according to (1) or (2), wherein the personal attribute information is composed of basic information originating from each of the plurality of the players.

According to another aspect of the present invention as described in (3), what causes the shift to a special mode is the basic information originating from the players. This permits the providing of a game in which the players can feel a deeper connection to the other players.

(4) The gaming system according to any one from (1) to (3), wherein at least one of the players playing the game in the special mode has a greater advantage than in the normal mode.

According to another aspect of the present invention as described in (4), a game in a special mode may refer to a game in which the player has a greater advantage. Because of this configuration, the player who plays the game may feel some expectation so that the player may have more pleasure in playing.

(5) The gaming system according to any one from (1) to (4), wherein game credits which serve as virtual currencies transferable among the players during the game and which are used for determining respective ranking positions of the players are awarded in a larger amount to a winner of the game in the special mode than in the normal mode.

According to another aspect of the present invention as described in (5), a game in a special mode is provided such that the player can obtain more game credits in the game in the special mode. This can cause a deeper feeling of expectation by the player.

(6) The gaming system for providing a game, comprising: a gaming machine connected to a communications network; and a gaming server connected to the communications network, wherein the gaming server comprising: a storage device for storing personal attribute information corresponding to each of a plurality of players; and a control device for determining whether the game is caused to shift from a normal mode to a special mode, and wherein the control device determines whether the game is caused to shift to another special mode being entitled with a game name based on features of the personal attribute information so that a title after the game name is awarded to a winner of the game.

(7) The gaming system according to (6), wherein the personal attribute information is composed of basic information originating from each of the plurality of players.

(8) The gaming system according to (6) or (7), wherein at least one of the players with the game in the special mode has a greater advantage than in the normal mode.

(9) The gaming system according to any one from (6) to (8), wherein game credits which serve as virtual currencies transferable among the players during the game and which are used for determining ranking positions of the players are awarded by the control device in a larger amount to a winner of the game in the special mode than in the normal mode.

(10). A gaming method utilizing a gaming machine connected to a communications network; and a gaming server provided with a personal attribute information storing region for storing personal attribute information corresponding to each of a plurality of players participating in a game, the gaming method comprising: determining whether an event for causing the game to shift to a special mode entitled a game name based on features of the personal attribute information is to be generated; transmitting a signal for causing the game to shift to the special mode to the gaming machine through the communications network in response to the generated event; and awarding a title after the game name to a winner of the game according to the generated event

Here, the personal attribute information storing region may include a storage device such as a hard disk, a flexible disk, a compact disk, a memory, and so on.

(11) The gaming method according to (10), further comprising:

generating a player group based on the features of the personal attribute information; and determining whether an event for causing the game to shift to the special mode is to be generated based on the features of the personal attribute information of each of the players of the player group.

(12) The gaming method according to (10) or (11), wherein the personal attribute information comprises basic information originating from each of the players.

(13) The gaming method according to any one from (10) to (12), wherein at least one of the players with the game in the special mode has a greater advantage than before shifting.

(14) The gaming method according to any one of from (10) to (13), wherein game credits which serve as virtual currencies transferable among the players during the game and which are used for determining ranking positions of the players are awarded in a larger amount to a winner of the game in the special mode than before shifting.

Further features of the present invention, its nature, and various advantages will be more apparent from the accompanying drawings and the following detailed description of the present invention.

### BRIEF DESCRIPTION OF THE DRAWINGS

FIG. 1 is a schematic view showing a gaming system according to an embodiment of the present invention.

FIG. 2 shows a schematic perspective view of a gaming machine group according to an embodiment of the present invention.

FIG. 3 is a schematic perspective view of a gaming machine of a gaming machine group according to an embodiment of the present invention.

FIG. 4A is a block diagram showing a gaming server according to an embodiment of the present invention.

FIG. 4B is a hardware block diagram showing a gaming server according to another embodiment of the present invention.

FIG. 5 is an image diagram showing a personal basic information table of personal basic information managed and stored by a gaming server.

FIG. 6 is an image diagram showing a personal rank table for storing personal rank information managed by a gaming server.

FIG. 7 is an image diagram showing a personal ‘yakuman’ (patterns of the highest score) achievement table for storing personal ‘yakuman’ achievement information managed by a gaming server.

FIG. 8 is an image diagram showing an event grade correspondence table used for determining the grade of generated special events according to an embodiment of the present invention.

FIG. 9 is a hardware block diagram showing a gaming machine group according to an embodiment of the present invention.

FIG. 10 is a block diagram showing a gaming machine of a gaming machine group according to an embodiment of the present invention.

FIG. 11 is a flowchart showing procedures according to an embodiment of the present invention.

FIG. 12 is a flowchart showing procedures according to an embodiment of the present invention.

FIG. 13 is a displayed image on a display unit of a gaming machine of a gaming machine group according to an embodiment of the present invention.

FIG. 14 is an example image of players' personal achievement according to an embodiment of the present invention.

FIG. 15 is a list of birthstones used as game credits according to an embodiment of the present invention.

FIG. 16 is a displayed image in a generated special event on a display unit of a gaming machine of a gaming machine group according to an embodiment of the present invention.

FIG. 17 is a diagram showing an example of rank criteria for personal rank according to an embodiment of the present invention.

FIG. 18 is a display image of personal rank displayed on a display unit of a gaming machine of a gaming machine group according to an embodiment of the present invention.

FIG. 19 is a displayed image indicating the kinds of ‘yakuman’ rank according to an embodiment of the present invention.

FIG. 20 is an image of a rewritable magnetic card used for player authentication according to an embodiment of the present invention.

### DETAILED DESCRIPTION OF THE INVENTION

A preferred embodiment of the present invention is described below in reference to the drawings.

The following is described, by way of example, with a gaming machine used for playing mah-jong according to an embodiment of the present invention.

In addition to such a gaming machine used for playing mah-jong (so-called video mah-jong), it should be understood that the present invention may be applied to a gaming machine used for playing card games such as blackjack and hanafuda (Japanese playing cards) where winners and losers are determined among a plurality of players on the basis of their own hands (combinations of card patterns).

[Network Configuration of Gaming System]

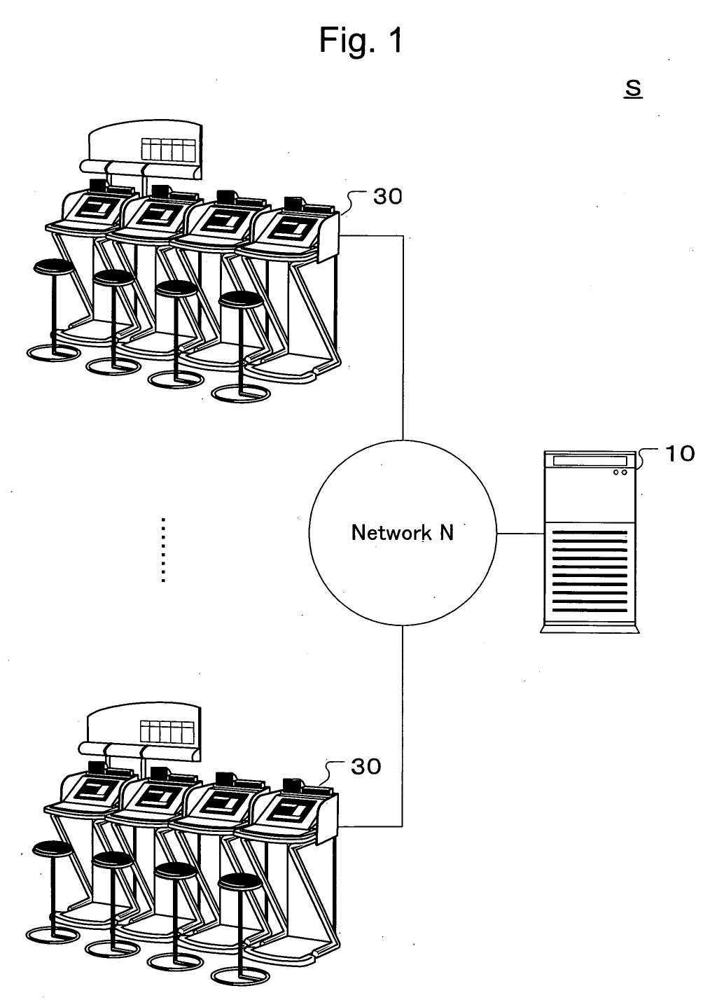

FIG. 1 is a network configuration diagram of a gaming system S according to this embodiment of the present invention.

A network N links a gaming server 10 for national on-line match-up type (or on-line competitive) mah-jong according to an embodiment of the present invention and gaming machine groups 30 for national on-line match-up type (or on-line competitive) mah-jong according to an embodiment of the present invention, the latter being installed in various facilities.

The gaming server 10 has functions of: authenticating the players by logging into the gaming machine groups 30; managing the game played in remote locations via the network N; and managing personal attribute information containing the personal basic information and the game achievement history information, such as rank and ‘yakuman’ achievement, of the players. The network N is composed of a dedicated line based on the TCP/IP protocol.

Each of gaming terminals 40A, 40B, 40C, etc. is assigned to each player so that the players play mah-jong. With each of the gaming terminals 40A, 40B, 40C, etc. each player manages his or her own mah-jong tiles, which may be equivalent to cards in a card game, and input instructions of predetermined mah-jong actions such as ‘tsumo’, ‘dapai,’ ‘chii,’ ‘pon,’ ‘kan,’ and ‘ron.’

In this embodiment, each gaming machine group 30 comprises four gaming terminals and is installed in each of the facilities. However, the present invention is not limited to this configuration. That is, an arbitrary number of gaming terminals may be installed in each of the facilities.

Further, in this embodiment, the network N linking the gaming server 10 and the gaming machine groups 30 installed in the respective facilities is composed of a dedicated line. However, the present invention is not limited to this configuration. That is, the network N may be composed of a VPN (virtual private network) implemented on the Internet using a public network.

[Outline of Gaming Machine Group]

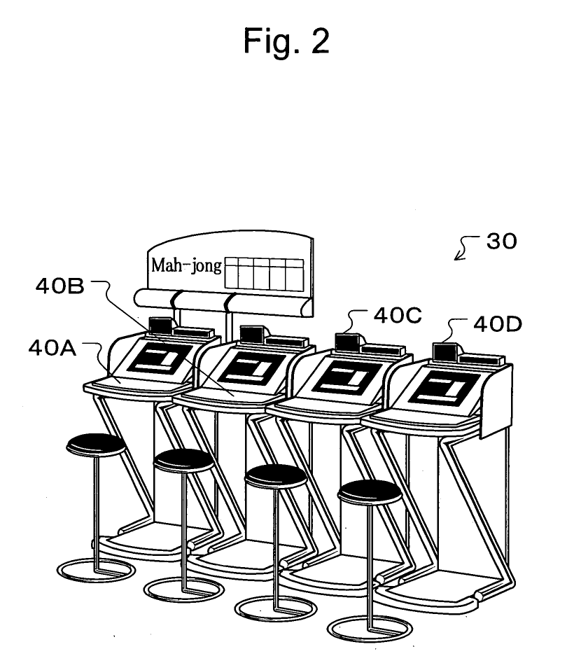

FIG. 2 is a perspective view showing schematically one of the gaming machine groups 30 according to this embodiment of the present invention.

The gaming machine group 30 comprises four separate gaming terminals 40A, 40B, 40C, and 40D.

However, as described above, the gaming machine group 30 does not necessarily need to comprises four gaming terminals. Instead, only a single gaming terminal may be installed in a facility at each location and may be connected to the network N so as to provide the game.

[Gaming Terminals 40A, 40B, 40C, and 40D]

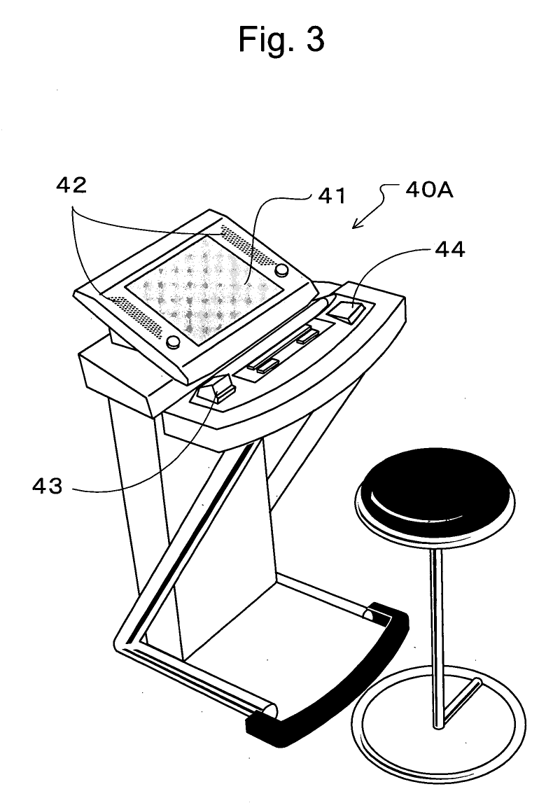

FIG. 3 is a perspective view showing schematically one of the separate gaming terminals 40A, 40B, 40C, and 40D constituting the gaming machine group 30 according to this embodiment of the present invention. The four gaming terminals are identical to each other. Thus, this figure shows a typical appearance of the gaming terminal 40A.

The gaming terminal 40A comprises a display device 41 which is arranged so as to face the player and has the function of displaying an image necessary for the game.

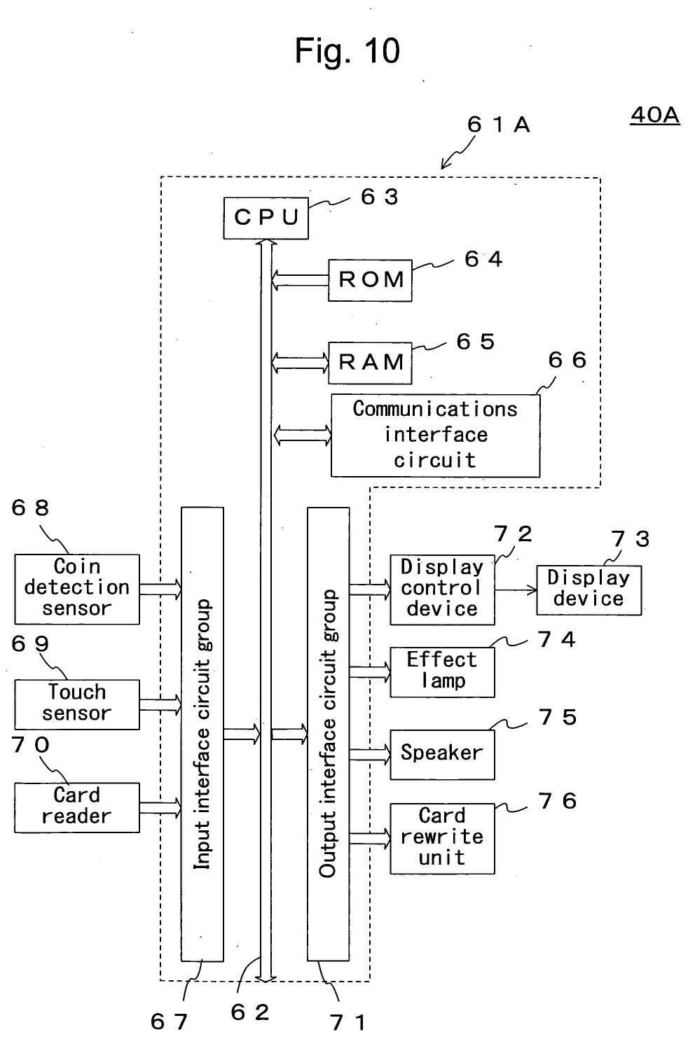

The surface of the display device is provided with a touch sensor 69 (see FIG. 10) for allowing the player to operate with the game by locating a position and measuring a timing of a touch on the display device.

Further, a speaker 75 is built in the gaming terminal 40A, so that sound generated causes excitement in the game through speaker grills 42 provided on both sides of the display device 41.

A coin insertion slot 43 used for playing the game is provided on the player side of the gaming terminal 40A. A coin detection sensor 68 (see FIG. 10) built in the gaming terminal 40A detects a coin.

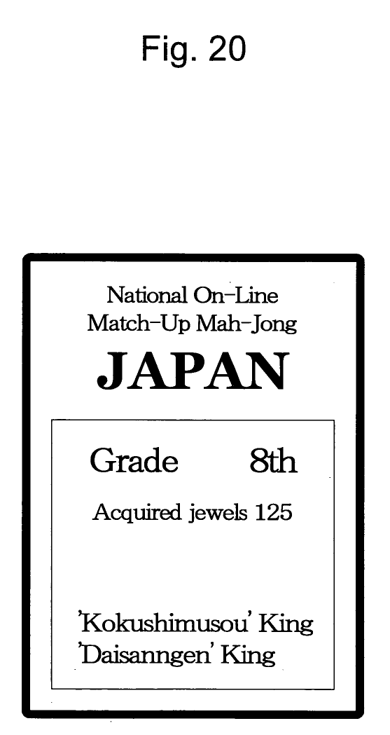

An insertion opening 44 into which a rewritable magnetic card (see FIG. 20) for player authentication is inserted is provided on the player side of the gaming terminal 40A. The rewritable magnetic card is inserted into a card reader 70 (see FIG. 10) of the gaming terminal 40A, so that the authentication information recorded on the rewritable magnetic card is read.

In this embodiment, the card reader 70 reads information from the rewritable magnetic card, so as to identify the player. However, the present invention is not limited to this configuration. That is, any kind of recording medium, such as an IC chip built-in card, capable of recording the player's attribute information may be used.

[Electrical Configuration of Gaming Server 10]

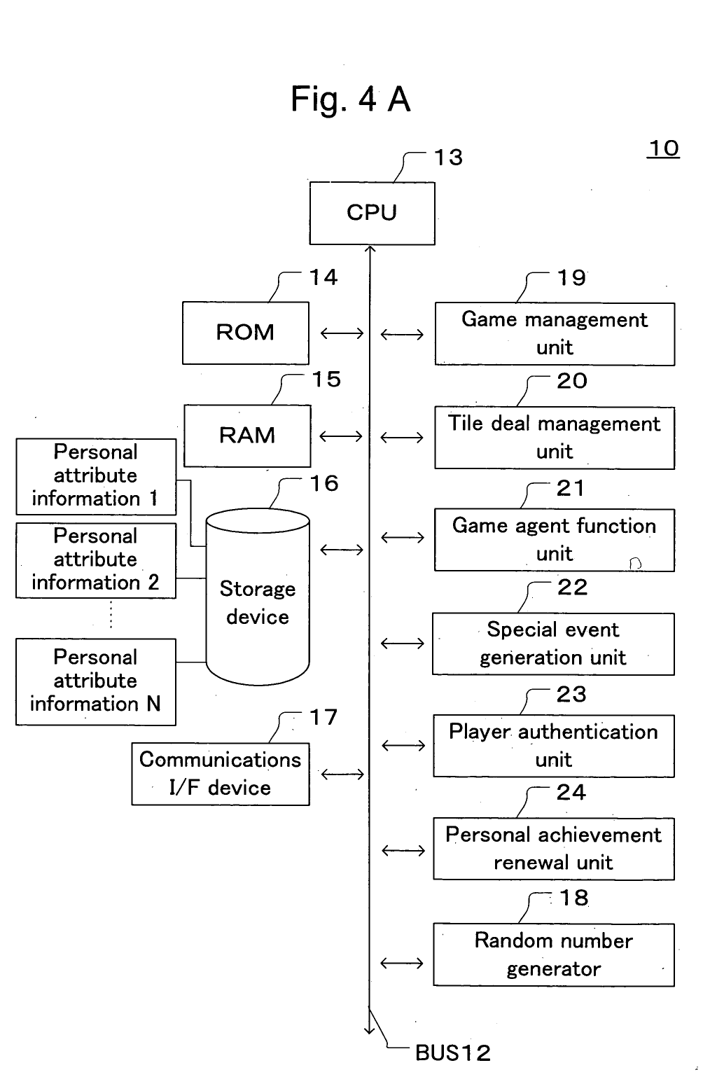

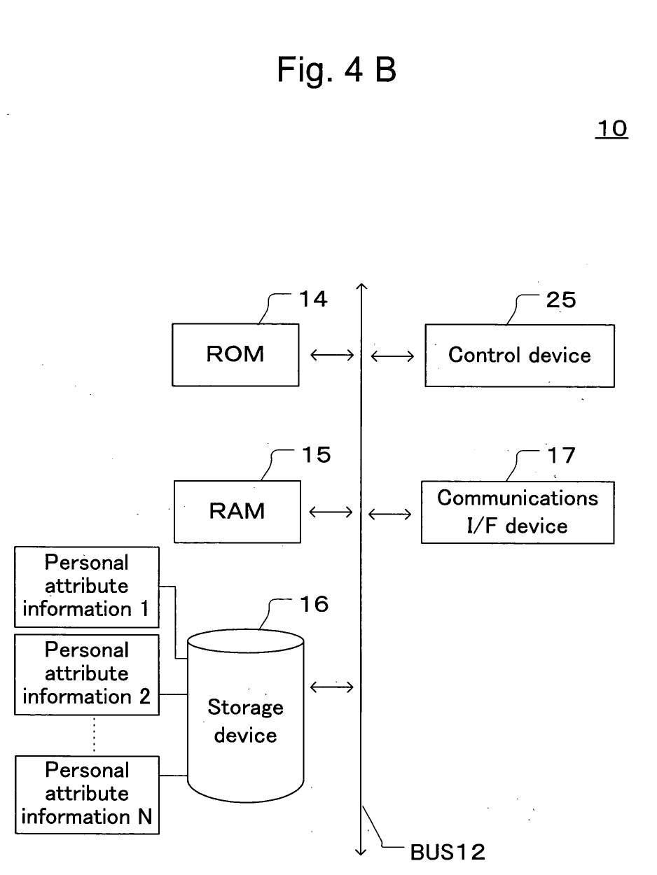

FIG. 4A is a block diagram showing the hardware of the gaming server 10 of the gaming system according to this embodiment of the present invention. The gaming server 10 comprises a BUS 12. The BUS 12 links: a CPU 13; a ROM 14; a RAM 15; a storage device 16 carrying a database for storing later-described personal attribute information (a personal basic information table, a personal rank table, and a personal ‘yakuman’ achievement table); a communications I/F device 17 for controlling connection with the network N; and a random number generator 18.

The BUS 12 further links: a game management unit 19 for forming (or grouping) a player group of four players playing a mah-jong game in the gaming system S according to an embodiment of the present invention and for managing the player group; a tile deal management unit 20 for managing ‘haipai’ (distributing of tiles), ‘tsumo’ (self-drawing a tile), and ‘sutepai’ (discarding a tile) in the game in cooperation with the random number generator 18 under control of the CPU 13; a game agent function unit 21 for allowing the gaming server 10 to serve as a virtual player (or agent) playing the game when the game management unit 19 cannot form a group of four players, that is, when the number of players participating in the game is fewer than four which may be the requirement of the game; a special event generation unit 22 for retrieving the personal attribute information of the players participating in a game, at the beginning of the game so as to determine an event to be generated, on the basis of the personal attribute information; a player authentication unit 23 for authenticating the players when the players participating in the game with the gaming machine group 30 log into the gaming system S according to an embodiment of the present invention; and a personal achievement update unit 24 for renewing the personal game achievement into the newest one during the game or at the end of the game.

In the electrical configuration of the gaming server 10 according to another embodiment of the present invention as shown in FIG. 4B, the CPU 13, the game management unit 19, the tile deal management unit 20, the game agent function unit 21, the special event generation unit 22, the player authentication unit 23, the personal achievement update unit 24, and the random number generator 18 may be integrated into a control device 25.

Personal attribute information storing means is implemented by causing the control device 25 to operate according to a personal attribute information writing program so that personal attribute information is written into the database formed in the storage device 16.

Special game shift means is implemented by: causing the control device 25 to operate according-to a personal attribute information reading program so that the personal attribute information of the players participating in the game is read from the database formed in the storage device 16 and written into the RAM 15; then causing the control device 25 to operate according to a shift determination program so that whether the game in a normal mode is shifted to a special mode or not is determined on the basis of the features of the personal attribute information; and then causing the control device 25 to operate according to a game start signal transmission program if the shift to the special mode is to be carried out so that the game start signal is transmitted through the communications I/F device 17 to the gaming machine group 30.

Player group generating means is implemented by: causing the control device 25 to operate according to a personal attribute information reading program so that the personal attribute information of the players participating in the game is read from the database formed in the storage device 16 and written into the RAM 15; and then causing the control device to operate according to a player group generation program so that a player group is generated on the basis of features of the personal attribute information.

[Personal Attribute Information Managed by Gaming Server]

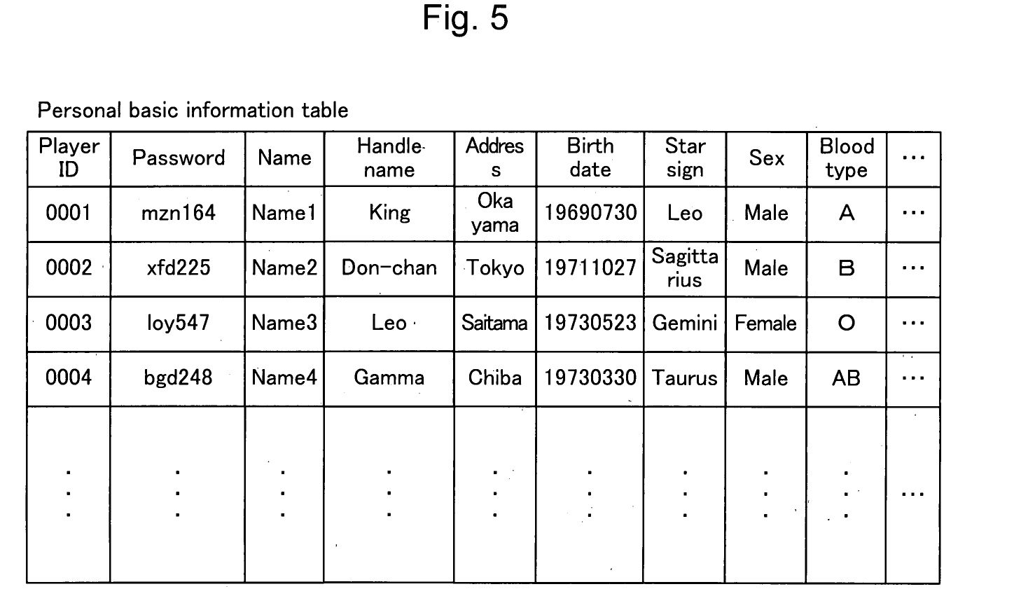

The personal attribute information managed in the gaming system S is described below in reference to FIGS. 5, 6, and 7. On the basis of the personal attribute information, the gaming server 10 of the gaming system S according to an embodiment of the present invention authenticates each player participating in the game in the gaming machine group 30, and determines the personal attribute information of the player, so as to generate a special event. FIGS. 5, 6, and 7 are sample image diagrams showing the personal attribute information.

FIG. 5 shows a personal basic information table. This table manages basic information solely, such as player IDs, passwords, names, handle names (nick names used in the game), addresses, birth dates, astrological signs, sex, and blood types of actual players. This table is used for identifying the player. When a player participates in a game, player authentication is performed so that the table is referred to in the player authentication. This table is also referred to when it is determined whether a special event is to be generated or not at the beginning of a game.

In order that a special event is generated as frequently as possible, the personal basic information preferably contains as many types or kinds of attributes as possible.

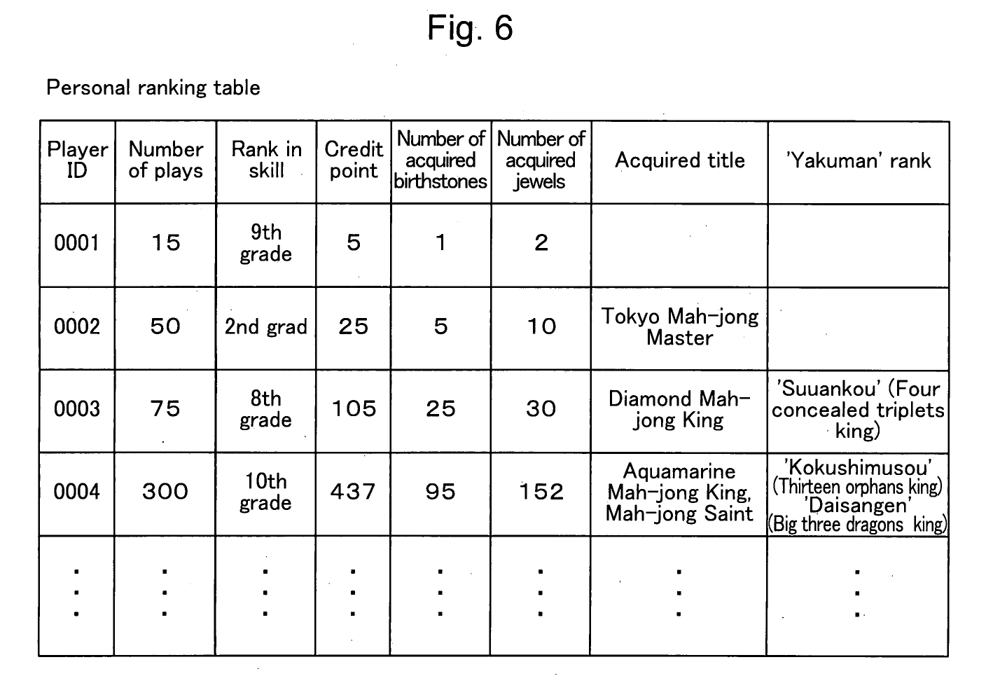

FIG. 6 shows a personal rank table for managing the history of the game achievement of each player. This table manages the game achievement solely, such as the number of plays of the game, rank (grades) in skill, acquired points, the number of acquired birthstones, the number of acquired jewels (other than birthstones), acquired titles, and ‘yakuman’ rank. This table is referred to when it is determined whether a special event is to be generated or not at the beginning of the game.

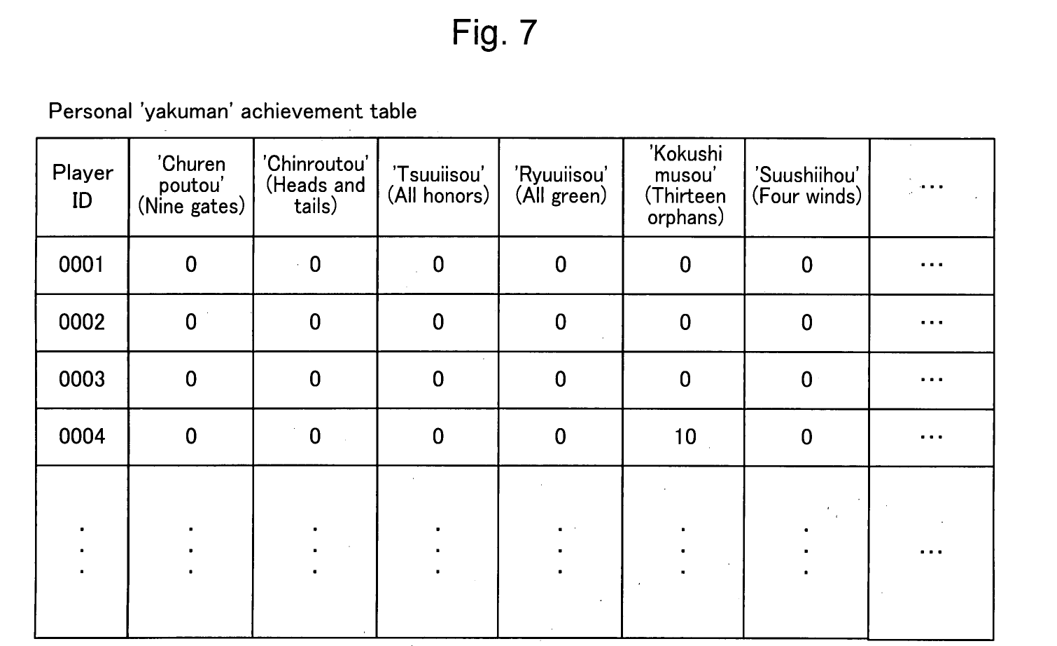

FIG. 7 shows a personal ‘yakuman’ achievement table for managing the history of the ‘yakuman’ accomplishment in games each player has played. The number of ‘yakuman’ accomplishments is managed for each of the ‘yakuman’ combinations. The personal achievement update unit 24 of the gaming server 10 refers to this table, and thereby awards a title to a player having achieved the largest number of accomplishments for each of the ‘yakuman’ combinations, so as to register this information into the column of ‘yakuman’ rank in the personal rank table.

In this embodiment, in addition to the ‘yakuman’ achievement, the number of accomplishments of winning combinations other than the ‘yakuman’ combinations may be recorded so that the players' rank may be re-evaluated and updated.

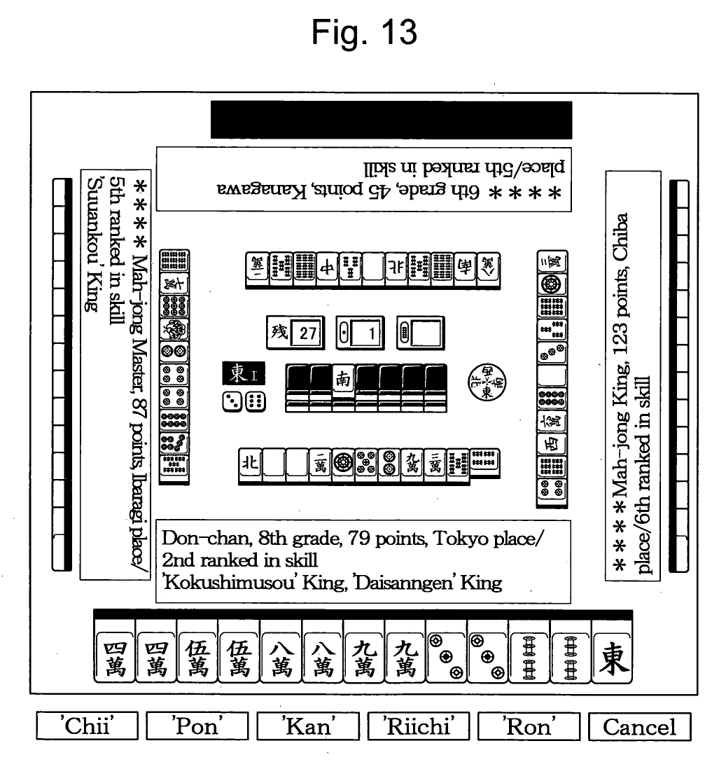

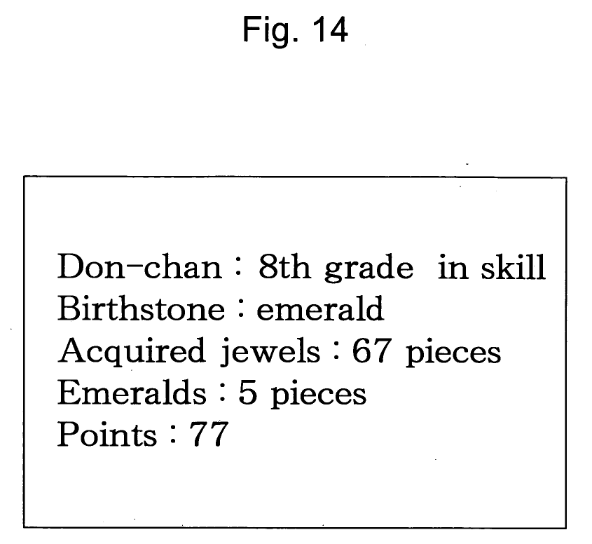

In the game according to an embodiment of the present invention, names of the players are displayed using their handle names (see FIGS. 13 and 14).

[Game Credits Used in a Game]

In the gaming machine according to an embodiment of the present invention, it is assumed that mah-jong is played by a group of four players. Two kinds of game credits are used.

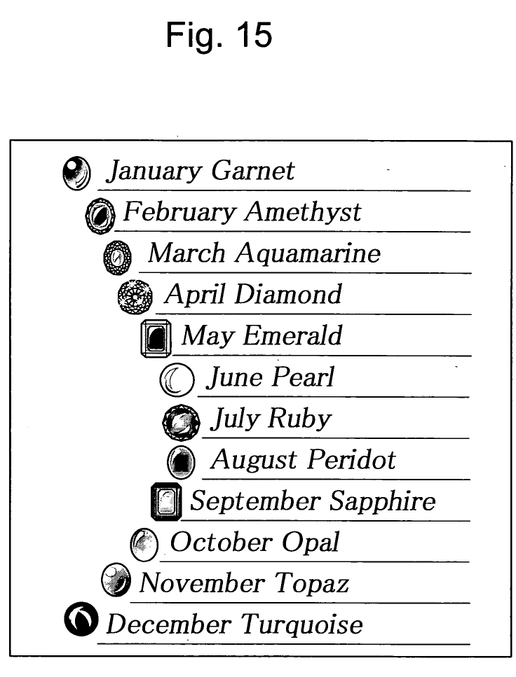

One kind is composed of jewels, that is, so-called birthstones. The birthstones include twelve types of jewels: January/garnet, February/amethyst, March/aquamarine, April/diamond, May/emerald, June/pearl, July/ruby, August/peridot, September/sapphire, October/opal, November/topaz, and December/turquoise (see FIG. 15).

In the game (mah-jong) according to an embodiment of the present invention, the players compete for the number of acquired jewels. That is, when all the players constituting the player group have dan (rank or grade in the skill), the winner (the highest-scored player) of a game (a round of the game) takes a jewel from the loser (the lowest-scored player). Further, if ‘yakuman’ is accomplished, the player who has won the ‘yakuman’ takes jewels from all other players when the player completes the ‘yakuman’ by ‘tsumo’ (self drawing), while the player who has won the ‘yakuman’ takes jewels from another player who discards a tile which completes and causes the ‘yakuman’ of the player. Further, when a player has lost all of his/her own point bars (chips for mah-jong) (so called “bankrupt” player) due to accomplishments by other players, the winner (the highest-scored player) of the round of the game takes a jewel from the “bankrupt” player.

The second kind is composed of points (credit points) acquired by each player. The credit points are awarded in the following manner on the basis of the final result of each score acquired by each player in the game:

the highest-scored player gains +6 points, the second highest-scored player gains ±0 point, the third highest-scored player loses 2 points (or gains −2 points), and the lowest-scored player loses 4 points (or gains −4 points). The credit points can also be added by converting the birthstones into credit points. The conversion is made in the following manner. One birthstone of the player's own is converted into three points while other jewels are converted into points at the one-to-one rate. These credit points are added to the above-mentioned credit points.

In the gaming system according to an embodiment of the present invention, ranking is performed on the basis of the number of acquired jewels and the number of acquired points so that players who are ranked first in the acquired jewels and the number of acquired points, respectively, receive respective titles.

Further, when a special event described later is generated, more game credits may be awarded to the players.

As such, two kinds of game credits are used in the game. This enhances the players' desires to participate in the game and the players may have more pleasure in the game itself so as to increases the players' sense of competition.

[Game Management Unit]

In this unit, when a plurality of players desire to make entries (e.g., insert coins so as to request player authentication) into the gaming terminals 40A, 40B, 40C, and 40D of the gaming machine group 30 in order to play a game at a certain time, and when the plurality of players participate in the game within a predetermined period of time from the certain time, the plurality of players are divided into player groups, each of which comprises a predetermined number of players appropriate to the game. For example, the players may be divided into groups having four players, respectively, in the case of mah-jong so that the game played among each of the generated player groups is managed. That is, this unit generates player groups having respective players, each of whom plays the same game among the same player group. Thus, it is managed who plays which game from the beginning of the game to the end of the game.

[Tile Deal Management Unit]

Under control of the CPU 13 and in cooperation with the random number generator 18, the tile deal management unit manages ‘haipai’ (dealing tiles) and ‘tsumopai’ (self-drawing a tile) in the same game. That is, in the specific game, the unit determines which tile is to be distributed to the player and which tile is to be drawn by the player.

[Game Agent Function Unit]

When the game management unit 19 cannot form a group of players who play the same game because of fewer participants, this unit allows the gaming server 10 to serve as a virtual player (or agent) playing the game. Under control of the CPU 13, this unit serves as a virtual player in the specific game so as to perform predetermined mah-jong actions, such as ‘tsumo,’ ‘dapai,’ ‘chii,’ ‘pon,’ ‘kan,’ and ‘riichi,’ similar to those carried out by an ordinary player.

[Player Authentication Unit]

When a player tries to participate in the game, this unit authenticates the player on the basis of whether or not the player's personal basic information has already been registered in the gaming server 10. This authentication is performed using a rewritable magnetic card. The information in the magnetic card is read by the card reader of the gaming terminal 40A, 40B, 40C, or 40D so that the player is identified on the basis of the combination of the player ID contained in the read-out personal basic information and a password input by the player through the touch panel. When the personal basic information of the player is not yet registered, a new registration is performed so that a new magnetic card is issued.

This embodiment uses a magnetic card. However, the present invention is not limited to this. That is, any kind of recording medium, such as an IC chip built-in card, capable of recording the personal basic information may be used.

[Special Event Generation Unit]

On the basis of the member attributes of each of the four players who belong to the same group formed by the game management unit 19 and who thereby play the same game, this unit determines whether or not an appropriate special event is to be generated. If a special event is to be generated, this unit determines which special event is to be generated, and then notifies the result of determination to the game management unit 19. On the basis of the notified result, the game management unit 19 manages the game. That is, using the player ID as a key, the game management unit 19 searches the personal basic information table of FIG. 5, the personal rank table of FIG. 6, and the personal ‘yakuman’ achievement table of FIG. 7 so as to read the player's attributes, the personal rank, and the ‘yakuman’ achievement into the RAM 15. Then, the game management unit 19 determines the agreement and the correspondence of the information so as to determine whether a special event is to be generated or not, and thereby executes the special event.

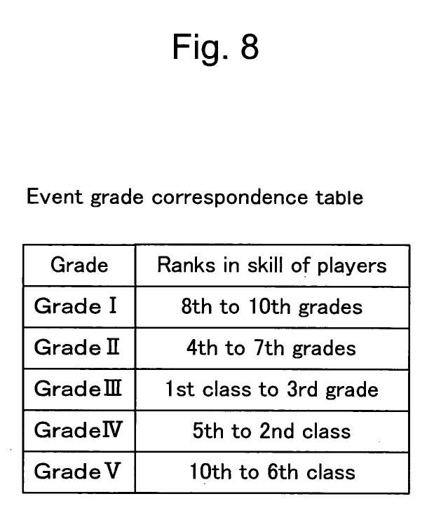

The game management unit 19 refers to the personal basic information table of FIG. 5 and the personal rank table of FIG. 6, and thereby finds common features in the attributes of the four players. Then, the game management unit 19 determines a game title name on the basis of such personal attribute information, and then generates an event with the game. At that time, the game management unit 19 refers to an event grade correspondence table shown in FIG. 8, and thereby determines the grade of the event to be generated, on the basis of the ranks of the four players in the game. Here, the grade of the event based on the ranks of the four players may be determined in various manners. For example, the grade may be determined on the basis of the lowest rank, the mean rank, or the highest rank.

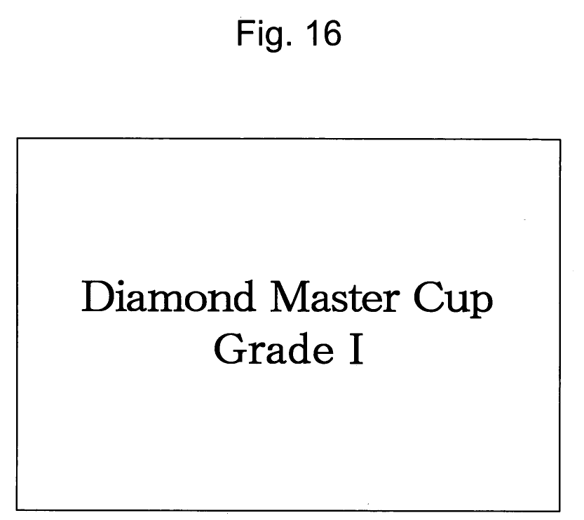

For example, when the birth dates of the four players who belong to the same group formed by the game management unit 19 and who thereby play the same game are all April, a title match entitled “Diamond Master Cup” after the birthstone of April may be held. At this time, the grade of this title match is determined on the basis of the data of the lowest rank of the four players in the game. For example, when the lowest rank of the four players is the eighth grade, this title match is entitled “Diamond Master Cup Grade I” (see FIG. 16), according to the event grade correspondence table.

When the addresses of the four players who belong to the same group formed by the game management unit 19 and who thereby play the same game are all in Tokyo, an event “Tokyo Master Cup Grade II” may be generated depending on the rank of the four players.

As a result, a game is provided in which the players do not merely enjoy the game with unknown players, but also can obtain the pleasure of playing the game in a special mode, so that the sense of expectation is enhanced.

Further, a game may be provided in which a special event is generated on the basis of the personal attribute information of each of the plurality of players, so that the players obtain a sense of any connection to the other players via the network N.

Furthermore, a special event may be generated when common features exist in various kinds of attributes, such as family name, personal name, sex, generation, blood type, and astrological signs (or star signs) of the four players who belong to the same group formed by the game management unit 19 and who thereby play the same game.

Further, regardless of the common features in the attributes of the four players who belong to the same group formed by the game management unit 19 and who thereby play the same game, a special event may be generated, for example, when the blood types of the four players are completely different from each other, that is, A, B, AB, and O, and hence when each player is a representative of the kind of the attribute.

As a result, a game is provided in which a special event is generated on the basis of the personal attribute originating from each of the plurality of players so that the players obtains a sense of a representative of a kind of attribute via the network N. This enhances the player's desire to participate in a game.

In the generation of the special event in the above-mentioned examples, four players are assumed to be present. However, even when a virtual player is generated by the function of the game agent function unit under control of the CPU 13 of the gaming server 10, the special event may be generated by finding common features in the attributes of the other players.

When the special event generation unit determines that the special event described above is to be generated, the special event generation unit transmits a signal for the event to the game management unit 19. On receiving the signal, the game management unit 19 stores that the game is based on this event, and then transmits a signal for notifying that the game is based on this event, to the gaming terminals used for this game.

[Personal Achievement Update Unit]

This unit updates the information of the personal rank table and the personal ‘yakuman’ achievement table during the game or at the end of the game. More specifically, when a player accomplishes ‘yakuman’ during the game, this unit updates the information of the personal ‘yakuman’ achievement table. Further, at the end of the game, this unit performs the processes of reflecting the number of jewels acquired in the game, the number of jewels lost, the credit points converted from these numbers, the credit points acquired on the basis of the final score position, and the credit points lost, into the final result of the credit points.

In one embodiment, a birthstone is converted into three points and that each of the other jewels is converted into one point. Further, the number of the credit points in the personal rank is updated in the following manner on the basis of the final score result with the game: the highest-scored player gains +6 points, the second highest-scored player gains ±0 point, the third highest-scored player loses 2 points (or gain −2 points), and the lowest-scored player loses 4 points (or gains −4 points).

On the basis of the credit points reflected in the above-mentioned processes, the game management unit 19 determines the national rank of the players and the prefectural rank of the players, so that a title “Mah-jong Saint” is awarded to the player ranked first in the national rank and that a title “Mah-jong Master” is awarded to the player ranked first prize in the prefectural rank. Then, the information of the acquired titles is updated in the personal rank. For example, the player ranked first prize in the credit points in Tokyo receives a title “Tokyo Mah-jong Master.”

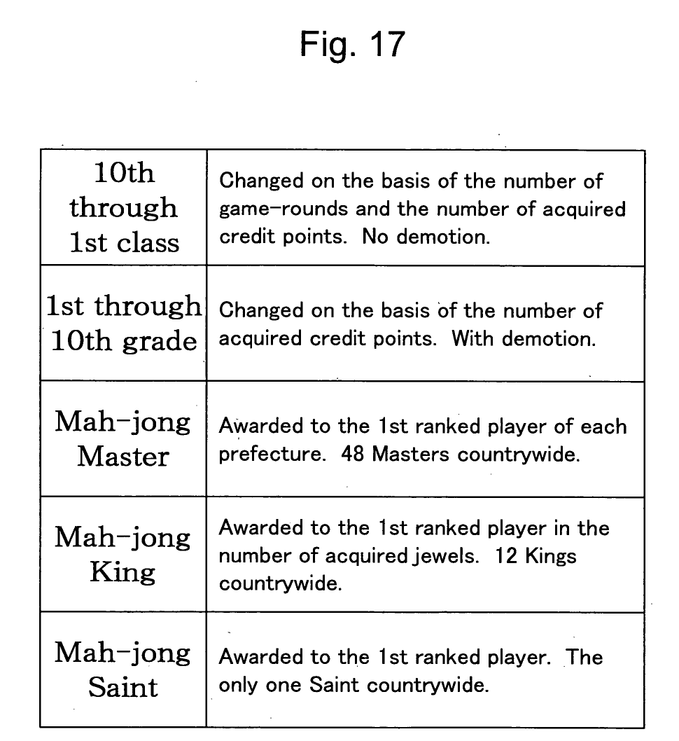

Further, on the basis of the credit points reflected in the above-mentioned process, the rank of the players is updated (see FIG. 17).

Furthermore, on the basis of the number of jewels reflected in the above-mentioned process, the player ranked first prize in the acquired number for each of the twelve birthstones is determined so as to receive the title “Mah-jong King.” Then, the information of the acquired titles is updated in the personal rank. For example, the player ranked first prize in the acquired number of diamonds receives a title “Diamond Mah-jong King” (see FIG. 17).

Similarly, at the end of the game, the information of the personal ‘yakuman’ achievement table is searched for the player having achieved the largest number of accomplishments for each ‘yakuman’ combination, so that a title is awarded to each player. Then, the information of the ‘yakuman’ rank is renewed in the personal rank.

After the renewal of the personal rank table and the personal ‘yakuman’ achievement table, this unit displays various kinds of achievement on the display unit of each gaming terminal. The display includes the following three.

First is the personal rank (not shown) based on the acquired credit points. This includes: “national-level personal rank” indicating the ranking position of each player in the country; “prefectural-level personal rank” indicating the ranking position of each player in the prefecture to which the player belongs; and “acquired jewel rank” showing the rank in each jewel serving as a game credit.

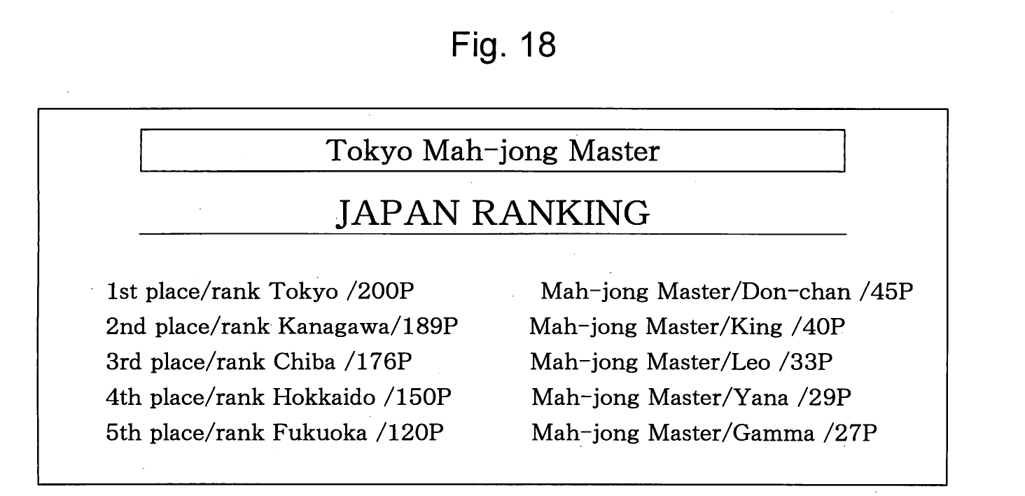

Second is “JAPAN rank” which is determined on the basis of the credit points of the players in each prefecture and which indicates the ranking position of each prefecture to which the players belong and the player, that is, “Mah-jong Master,” ranked first prize in each prefecture (see FIG. 18).

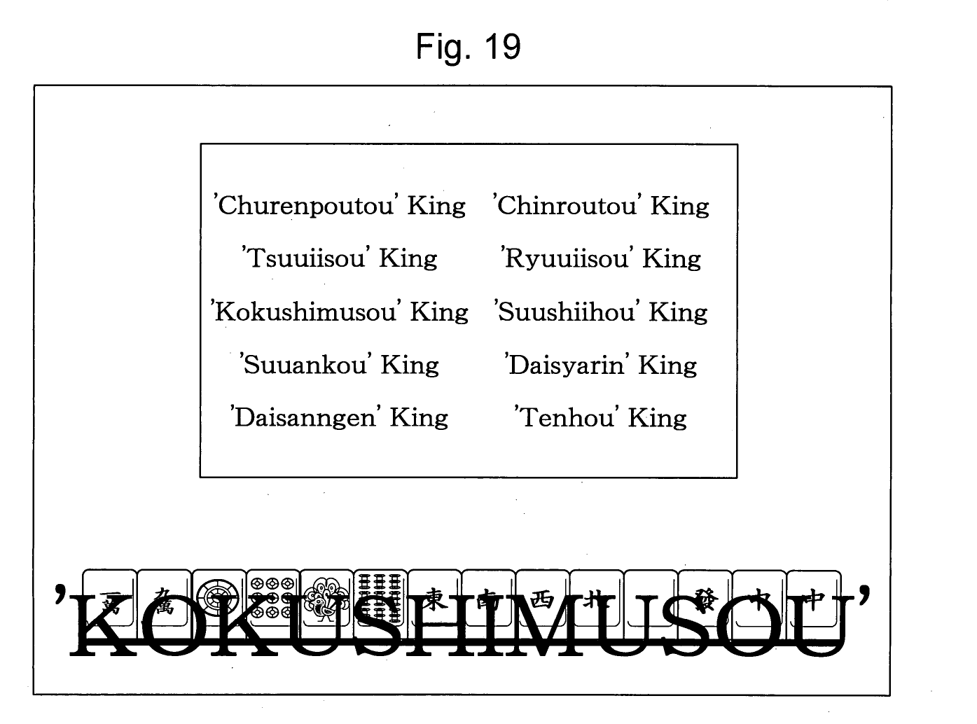

Third is “‘yakuman’ rank” showing the rank in the number of accomplishments for each ‘yakuman’ combination. The player having achieved the largest number of accomplishments for each ‘yakuman’ combination in the country receives a title after the name of the ‘yakuman’ combination. For example, the player having achieved the largest number of ‘kokusimusou’ (thirteen orphans) accomplishments receives a title “Kokusimusou King (see FIG. 19).”

FIG. 14 shows an example of these kinds of rank of a player.

The information of these kinds of rank is read from the rewritable magnetic card shown in FIG. 20 at the beginning of the game, and thereby always displayed on the game screen during the game (see FIG. 13).

As such, the rank of the players are performed on the basis of the game achievement, so that titles are awarded. This enhances the players' desire to participate in the game and the pleasure in the game itself, and thereby increases the players' sense of competition.

[Configuration of Gaming Machine Group]

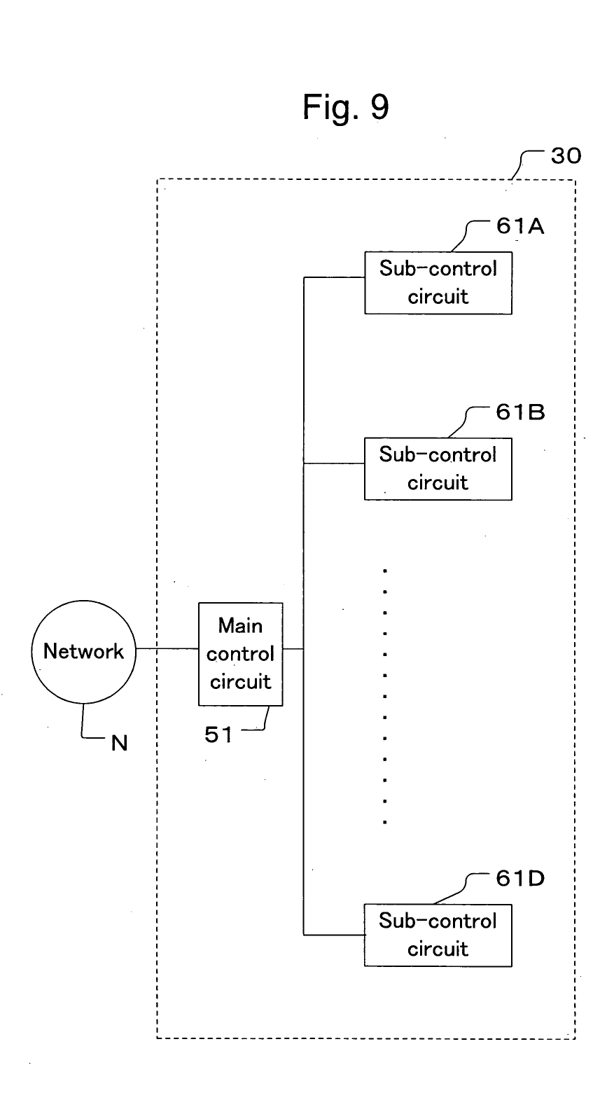

FIG. 9 is a block diagram showing the hardware of the gaming machine group 30.

The gaming machine group 30 comprises a plurality of separate gaming terminals 40A, 40B, etc. The gaming machine group 30 further comprises: a main control circuit 51 for controlling comprehensively these separate gaming terminals and for controlling the connection to the network N; and sub-control circuits 61A, 61B, etc. corresponding to the core control units of the separate gaming terminals 40A, 40B, etc.

[Configuration of Gaming Terminals]

FIG. 10 is a block diagram showing the hardware of the gaming terminals 40A, 40B, etc. This hardware block diagram is, by way of example, described using the gaming terminal 40A as a representative type.

The portion surrounded by a dashed line in FIG. 10 corresponds to the sub-control circuit 61A of the gaming terminal 40A which belongs to the gaming machine group 30.

The gaming terminal 40A comprises a BUS 62. The BUS 62 links a CPU 63, a ROM 64, a RAM 65, and a communications interface circuit 66.

Further, the BUS 62 links a coin detection sensor 68, a touch sensor 69, and a card reader 70 via an input interface circuit group 67.

Furthermore, the BUS 62 links a display control device 72, an effect lamp 74, a speaker 75, and a card rewrite unit 76 via an output interface circuit group 71.

The display control device 72 is connected to a display device 73.

In cooperation with the touch sensor 69, the display device 73 implements a so-called touch panel screen in which all the operations for the game can be detected by the touch sensor 69 detecting that the player touches the operation display unit of the display device 73, so that signals are provided to the CPU 63, whereby the game proceeds.

In this embodiment, the gaming terminal 40A is assumed to be composed of a dedicated game apparatus according to an embodiment of the present invention. However, the present invention is not limited to this. That is, an apparatus such as a personal computer (a desk top type or a notebook type), a PDA (personal digital assistant), and a cell phone with a browsing function, which is connectable to a network (e.g., the Internet), may be used.

In this embodiment of the present invention, the gaming terminal 40A does not have the function of managing the progress itself of the game (mah-jong, according to an embodiment of the present invention), and merely performs the operations of input and output for member authentication necessary for the player to participate in the game and for game operations necessary for advancing the game. The gaming terminal 40A provides merely the performance during the progress of the game so as to appeal to the senses of vision and hearing of the player through the display device and the speaker.

[Processes in Gaming Terminal]

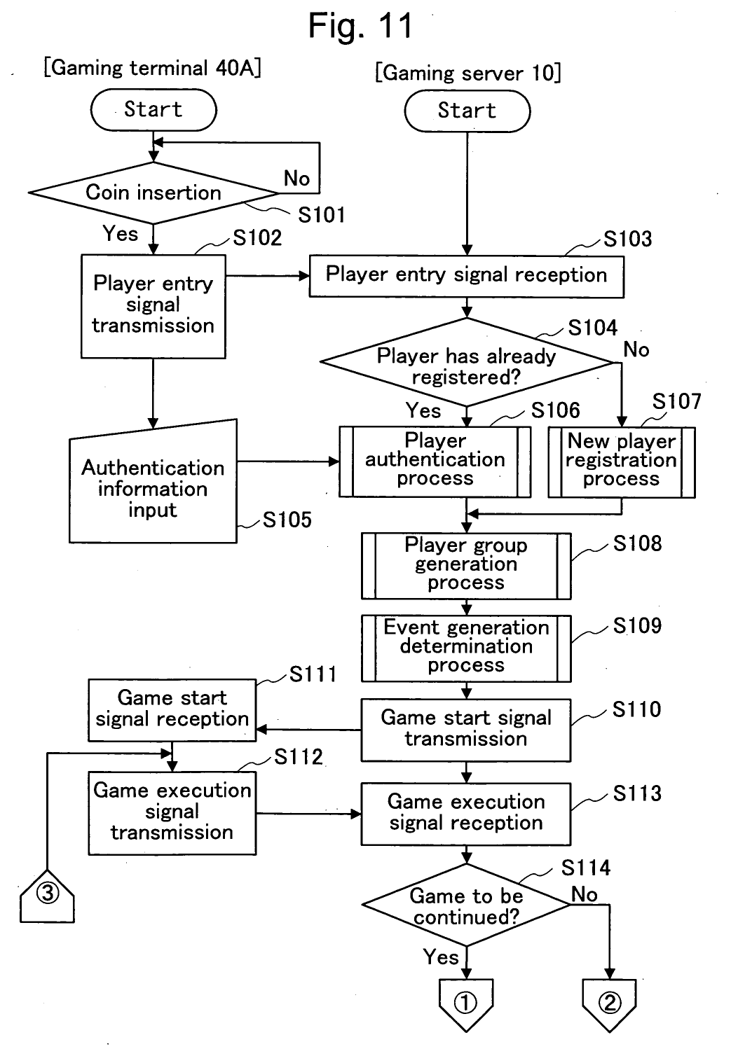

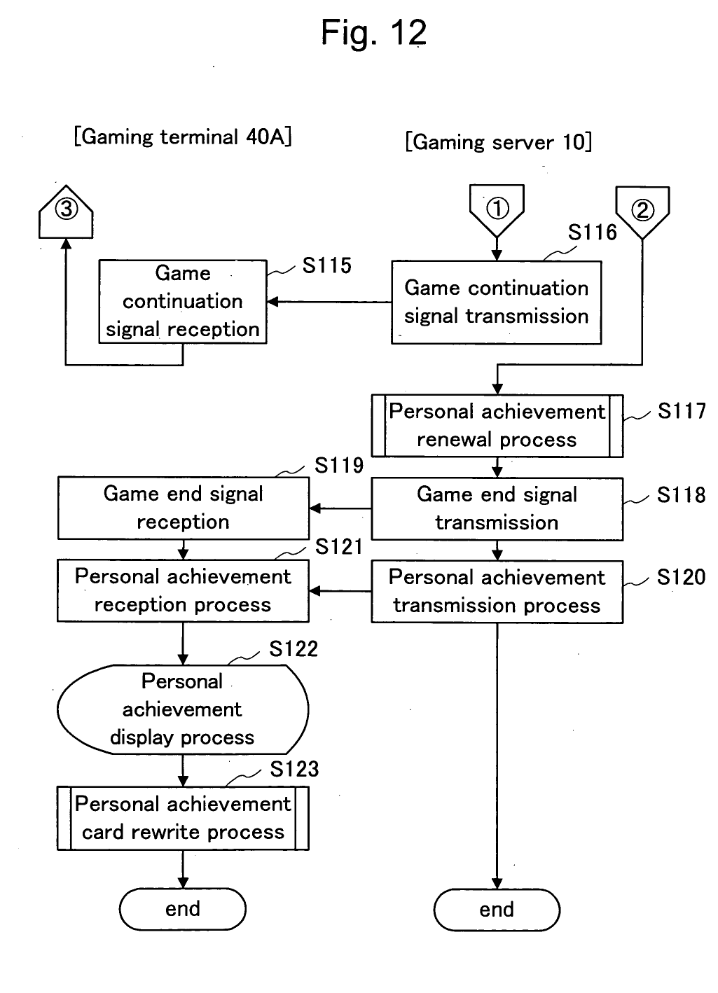

FIGS. 11 and 12 are flowcharts showing the process flow when a player is connected to the gaming server 10 through the gaming terminal 40A so as to play a game in the gaming system.

When a coin is inserted into the coin insertion slot of the gaming terminal 40A (step S101), the gaming terminal 40A transmits a player entry signal to the gaming server 10 (step S102). When the gaming server receives the player entry signal (step S103), the gaming server 10 refers to the personal basic information table in the database formed in the storage device 16 so as to determine whether or not the information of the player is already registered in the personal basic information table (step S104). When the information is already registered (Yes in step S104), the process of player acceptance is performed (step S105). When the information is not yet registered (No in step S104), the process of new player registration is performed (step S107). This process of new player registration is a general one, in which a new member is introduced through the gaming terminal 40A via the network N so that a player ID and a password is provided to each newly registered member. Then, member personal basic information, such as the items illustrated in the image diagram of the personal basic information table of FIG. 5, is collected.

When the information has already been registered, the player inserts the member card into the card reader of the gaming terminal 40A so that the information recorded in the member card is read and that the process of member authentication is performed. The gaming terminal 40A transmits the information read-out from the member card and the password inputted by the player through the touch sensor 69, to the gaming server 10 (step S105), so that the gaming server 10 performs the process of member authentication (step S106).

When authentication as an appropriate member is obtained in this process, the process of forming a player group is performed (step S108). In this process, players having declared participation in a game within a predetermined period of time from a certain point of time are divided into player groups, each of which comprises four players in the case of mah-jong, for example. Then, the game is started among the player group. When the number of players having declared participation within a predetermined period of time is less than the predetermined number of players of the player group (for example, four players in the case of mah-jong), the game agent function unit 21 of the gaming server 10 serves as a player agent under control of the CPU 13 so that the game is started.

Before the start of the game, it is determined whether or not the game corresponds to a special event (step S109). Under control of the CPU 13, the special event generation unit 22 refers to the personal basic information table and the personal rank table in the database stored in the storage device 16, and thereby reads all the attributes and the achievement of the players into the RAM 15. Then, the special event generation unit 22 determines an event to be generated, on the basis of the read-out information and the event grade correspondence table of FIG. 8.

For example, when the birth months of the players who belong to the player group are all April, and when all the players have a grade higher than the eighth grade, a special event “Diamond Master Cup Grade I” is generated. Then, the player ranked first prize in the final results in the game generated by this event receives a title “Diamond Master.” Alternatively, when the blood types of the players who belong to the player group are all A-type, and when all the players have a grade higher than the sixth grade, a special event “Blood Type-A Master Cup Grade II” is generated.

Further, when every player who belongs to the player group is “Mah-jong Master” of any prefecture, a special event “Mah-jong Master Match” is generated.

As such, various special events can be generated on the basis of the personal attribute information, such as the personal basic information and the personal rank information, of the players themselves, so that the winning player in the event can receive a title corresponding to the event.

On completion of these processes, the gaming server 10 transmits a game start signal to the gaming terminal 40A (step S110), so that the game (mah-jong) is started. FIG. 13 is a diagram showing the situation of progress of the game.

When the gaming terminal 40A receives the game start signal from the gaming server 10 (step S111), the gaming terminal 40A transmits signals for performing predetermined mah-jong operations (such as ‘tsumo,’ ‘dapai,’ ‘chii,’ ‘pon,’ ‘kan,’ and ‘ron’) and thereby executes the game, to the gaming server 10 (step S112).

When receiving a game execution signal from the gaming terminal 40A (step S113), the gaming server 10 performs a predetermined operation corresponding to the signal, and then determines whether or not the game can be continued. When the game can be continued (Yes in step S114), the gaming server 10 transmits a game continuation signal to the gaming terminal 40A (step S116). On receiving this signal (step S115), the gaming terminal 40A continues to transmit a game execution signal to the gaming server 10 (step S112). In contrast, when the game cannot be continued (No in step S114), the game is terminated, and then the process of personal achievement update is performed (step S117). That is, the information of the personal rank table and the personal ‘yakuman’ achievement table is updated, and then the procedure advances to the next step.

At this time, the game is finished so that the gaming server 10 transmits a game end signal to the gaming terminal 40A (step S118). When the gaming terminal 40A receives the game end signal (step S119), the gaming server 10 further transmits the up-to-date personal achievement information (step S120). On receiving the up-to-date personal achievement information (step S121), the gaming terminal 40A displays the information on the display device 73 (step S122), and then rewrites the information into the magnetic card (see FIG. 20) (step S123).

At this time, the processes of the game (mah-jong) in which a special event is generated are completed.

According to the present invention, a game is provided in which the players do not merely enjoy the game with unknown players, but also can obtain pleasure of playing the game in a special mode so that the sense of expectation is enhanced.

What is claimed is:

1. A gaming system for providing a game, comprising:
personal attribute information storing means for storing personal attribute information corresponding to each of a plurality of players; and
special game shift means for causing the game to shift from a normal mode to a special mode based on the personal attribute information of at least one of the plurality of players.

2. The gaming system according to claim 1, further comprising:
player group generating means for generating a player group being composed of at least the plurality of players based on the personal attribute information of each of the plurality of players,
wherein the game is caused to shift from the normal mode to the special mode based on the personal attribute information of each of the players of the player group.

3. The gaming system according to claim 1, wherein the personal attribute information is composed of basic information originating from each of the plurality of the players.

4. The gaming system according to claim 1, wherein at least one of the players playing the game in the special mode has a greater advantage than in the normal mode.

5. The gaming system according to claim 1, wherein game credits which serve as virtual currencies transferable among the players during the game and which are utilized for determining respective ranking positions of the players are awarded in a larger amount to a winner of the game in the special mode than in the normal mode.

6. A gaming system for providing a game, comprising:
(1) a gaming machine connected to a communications network; and
(2) a gaming server connected to the communications network,
wherein the gaming server comprising:
a storage device for storing personal attribute information corresponding to each of a plurality of players; and
a control device for determining whether the game is caused to shift from a normal mode to a special mode, and
wherein the control device determines whether the game is caused to shift to another special mode being entitled with a game name based on features of the personal attribute information so that a title after the game name is awarded to a winner of the game.

7. The gaming system according to claim 6, wherein the personal attribute information is composed of basic information originating from each of the plurality of players.

8. The gaming system according to claim 6, wherein at least one of the players with the game in the special mode has a greater advantage than in the normal mode.

9. The gaming system according to claim 6, wherein game credits which serve as virtual currencies transferable among the players during the game and which are utilized for determining ranking positions of the players are awarded by the control device in a larger amount to a winner of the game in the special mode than in the normal mode.

10. A gaming method utilizing a gaming machine connected to a communications network; and a gaming server provided with a personal attribute information storing region for storing personal attribute information corresponding to each of a plurality of players participating in a game, the gaming method comprising:
determining whether an event for causing the game to shift to a special mode entitled a game name based on features of the personal attribute information is to be generated;
transmitting a signal for causing the game to shift to the special mode to the gaming machine through the communications network in response to the generated event; and
awarding a title after the game name to a winner of the game according to the generated event

11. The gaming method according to claim 10, further comprising:
generating a player group based on the features of the personal attribute information; and
determining whether an event for causing the game to shift to the special mode is to be generated based on the features of the personal attribute information of each of the players of the player group.

12. The gaming method according to claim 10, wherein the personal attribute information comprises basic information originating from each of the players.

13. The gaming method according to claim 10, wherein at least one of the players with the game in the special mode has a greater advantage than before shifting.

14. The gaming method according to claim 10, wherein game credits which serve as virtual currencies transferable among the players during the game and which are utilized for determining ranking positions of the players are awarded in a larger amount to a winner of the game in the special mode than before shifting.
